(19) United States
(12) Patent Application Publication
(10) Pub. No.: US 2025/0391927 A1
(43) Pub. Date: Dec. 25, 2025

(54) Alkaline Electrochemical Generators with a Zinc Anode

(71) Applicant: SUNERGY, Rosny-sous-Bois (FR)

(72) Inventors: Fabrice Fourgeot, Fontenay-sous-Bois (FR); Shadi Mirhashemihaghighi, Rosny-sous-Bois (FR)

(21) Appl. No.: 18/837,717

(22) PCT Filed: Feb. 10, 2023
(86) PCT No.: PCT/IB2023/051209

§ 371 Date: Aug. 12, 2024

(30) Foreign Application Priority Data
Feb. 17, 2022 (FR) FR2201375

(51) Int. Cl. H01M 10/26; H01M 4/24

(52) U.S. Cl. CPC H01M 10/26; H01M 4/244; H01M 2300/0014

(57) ABSTRACT

The invention relates to zinc-anode electrochemical generators and more particularly to storage batteries. The invention relates especially to zinc-anode secondary generators. More specifically, the invention is directed to an electrochemical generator with zinc electrode that contains an electrolyte which is an alkaline aqueous solution having a molarity of between 4M and 15M of hydroxyl anions and compromising: a) at least one wetting agent at a concentration of between 0.1 g/l and 50 g/l of electrolyte; and b) at least one antifoam agent in an amount of between 10 mg and 1,000 mg per kilogram of electrolyte; a particular feature of this electrochemical generator is that—the electrolyte comprises the ionic wetting agent bis(2-ethylhexyl) phosphate; and/or—the electrolyte comprises at least one nonionic wetting agent selected from alkyl polyglucosides and from polyethylene glycol alkylphenol ethers; and/or—the antifoam agents are selected from polyorganosiloxanes. The invention further pertains to a method for producing such a generator.

The present invention relates to the field of alkaline electrochemical S and more particularly to storage batteries. It relates especially to zinc-anode secondary generators such as nickel-zinc, zinc-manganese dioxide, silver-zinc, and zinc-air, as well as those including a totally or partially soluble cathode such as zinc-iodine, zinc-bromine, zinc-ferricyanide, and zinc-manganese oxide, and is intended to obtain a high number of cycles with the zinc electrode.

### STATE OF THE ART

Zinc's energy characteristics (820 Ah/kg, 5,845 Ah/l), its electronegativity (1.65V), its low cost, and its ease of recycling make it a particularly interesting electrochemical generator anode material; thus, the theoretical mass energies of the nickel-zinc and zinc-air pairs are 334 Wh/kg and 1,320 Wh/kg, respectively. In practice, the mass energy of nickel-zinc batteries can reach 80 Wh/kg in prismatic format, which is two to three times that of lead-acid batteries.

However, while zinc is heavily used in Leclanche® batteries and alkaline batteries, it is absent from industrial alkaline batteries, with the exception of silver-zinc batteries, whose use is limited to a few cycles and which are used mainly for military applications, and more recently the first nickel-zinc industrial batteries.

Zinc is soluble in an alkaline medium in the form of zincates and easily forms, when zinc-anode batteries are charged, dendritic growths that cause short-circuits between electrodes of opposite polarities.

Furthermore, the areas of the negative electrode where the zinc is deposited evolve during charging and discharging cycles; thus, densification phenomena are observed, which reduce the porosity of the electrode and consequently its ability to operate at current densities corresponding to a practical use of the batteries. Other factors penalize the zinc anode, such as the precipitation of zinc oxide forming a layer that passively reduces the active surface of the electrode.

Much work has been done to understand zinc's mechanisms of deposition and dissolution in an alkaline medium, and a large number of patents have been filed that propose various solutions:
The bulk of patents involve the use of additives added to the electrolyte or incorporated into the anodic active material, with the aim of reducing zincate solubility.
There are also mechanical methods described that allow for the circulation of the electrolyte alone or a zinc electrode dispersed in the electrolyte, so as to prevent dendritic growth by ensuring homogeneous zinc deposition.
The use of pulsed currents, with or without polarity reversal, allow the dendrites to at least partially dissolve.
Finally, separators may be used that limit the formation or suppress the diffusion of zincate ions from the anode to the cathode. These are, for example, microporous separators in multiple layers or exchange membranes.

These various techniques can be implemented alone or in combination, but they provide only part of the solution, and depending on the case, they may increase the internal resistance, drive up the cost of the battery, or prove to be complex to implement. Also, some recommend the addition of lead or cadmium to the active mass of the anode, which is clearly unacceptable due to pollution concerns.

Progress has been made by adding additives to the electrolyte consisting mainly of potash, as is the case with small nickel-zinc (NiZn) cylindrical batteries available on the market. Nevertheless, the number of cycles obtained does not meet the usage needs of industrial batteries and batteries for stationary applications, which must respectively ensure at least 1,000 and 2,000 deep charge and discharge cycles, corresponding to a depth of discharge of 80% and higher.

A first singular advance was made by the addition of conductive ceramics, preferably titanium nitride (TiN), to the zinc electrode, an innovation described by patent FR 2,788,887 (filed on Jan. 27, 1999, by SCPS), making it possible to exceed 1,000 cycles at a depth of discharge of 80% and beyond. A second remarkable advance was made by the addition of SiO₂ to the electrolyte, an innovation described by patent FR 3,099,851 (filed on Aug. 9, 2019 by Sunergy), making it possible to exceed 2,000 cycles at a depth of discharge of 80% and beyond.

The loss of capacity of NiZn batteries in cycling is historically correlated mainly with the formation of zinc dendrites that ultimately form a short circuit. This formation of dendrites was suppressed as a result of the work of SCPC [sic] related to the aforementioned patent FR 2,788,887, making it possible to achieve more than 1,000 cycles. Subsequently, the loss of the capacity of the NiZn batteries was induced by the redistribution, densification of the active material, drying, and passivation of the zinc electrodes. A new response to these limits in the stability of NiZn batteries has been demonstrated with Sunergy's work related to the aforementioned patent FR 3,099,851, making it possible to exceed 2,000 cycles and more. With the increase in the stability of the zinc electrode, the loss of capacity was associated with other parameters in addition to those already mentioned, such as the stability of the membrane's hydrophilic properties.

The purpose of the present invention is to provide a novel response to the limits affecting the ability of zinc electrode-based batteries to provide a large number of cycles, a response provided by stabilizing the membrane's hydrophilic properties while maintaining the advances that have made it possible to achieve more than 2,000 cycles.

To do this, tests concern the addition of wetting agents to the electrolyte. The idea is to improve the solid-liquid contact surface for the active material of the nickel and zinc electrodes and to prevent a possible degradation of the membrane's hydrophilic properties. The assumption is that the wetting agents, which are soluble or suspended in the electrolyte, end up becoming trapped in part in the porosity of the membrane, allowing the membrane to retain its hydrophilic properties for longer.

Examination of the state of the art of zinc anode systems shows that there are several patents and studies mentioning the use of wetting agents. For example, Rossler et al. in patent U.S. Pat. No. 4,195,120, filed Nov. 3, 1978, states that the development of hydrogen in cells having zinc anodes is reduced or eliminated by incorporating into the cell a wetting agent that is an ethylene oxide polymer, alkyl adduct, phosphate ester. This wetting agent is added in such a way that, directly or upon wetting of the anode by the electrolyte, there is adsorption of the wetting agent to the surface of the zinc anode material, which prevents the release of hydrogen. The wetting agent is desirably present in the cell in an amount of 0.001% to 5% by weight of the cell's zinc component. The wetting agent described herein is soluble or dispersible in water and the alkaline electrolyte. The wetting agent is added either directly to the zinc electrode or indirectly to the electrolyte or cathode. Via the electrolyte, the wetting agent can be deposited on the surface of the zinc, while via the cathode, the wetting agent can pass through the membrane to be deposited on the zinc.

In Chinese patent application CN111048846, filed on Dec. 18, 2019, it is mentioned that a wetting agent selected from sodium lauryl sulfate, sodium dodecylbenzenesulfonate, cetyltrimethylammonium bromide, trimethyloctadecylammonium chloride, tetrabutylammonium bromide, one or more compounds from tetrabutylammonium hydroxide, tetrabutylammonium chloride, a perfluorinated surfactant make(s) it possible to improve the ability to increase the number of charge and discharge cycles from 100 to 600 by reducing the usual limitations, short-circuiting, dissolution, deformation, densification, passivation of the zinc electrode, and hydrogen development.

A 1998 article by JiLing Zhu et al. (Journal of Power Sources 72 (1998) 231-235) mentions the effects of different types of perfluorinated ionic wetting agents, including the hydrocarbon chain wetting agent CTAB, on the electrochemistry examined on the behavior of zinc. The results show that these wetting agents can be used as a mercury substitute to reduce corrosion in zinc batteries. It is also shown that zinc deposition in the presence of these wetting agents can be improved to a certain measure. The morphology of the electrodeposited zinc shows that these agents can provide more uniform and compact deposits and, consequently, reduce dendritic growth. FC-170C and CTAB are the most effective inhibitors. These ionic wetting agents remain attached to zinc during strong polarizations that are associated with hydrogen development, which is not the case for nonionic wetting agents. Cationic-type wetting agents can be adsorbed by the electrostatic attraction between the polar group of the molecules and the surface of the zinc electrode, such that the rate of hydrogen development increases more slowly in the presence of FC-135 or CTAB when the potential of the zinc electrode is more negative than −1.80V. The offsets of the deposition start potential and the maximum potential of the cathode current indicate that the deposition of zinc is inhibited to a certain extent in the presence of wetting agents. This is because the wetting agents are adsorbed on the surface of the zinc electrode to form a layer that has an inhibitory effect on the electroreduction process of zincate ions. Therefore, these wetting agents can slow down the rate of zinc deposition from zincates during the charging of the electrode and, thus, attenuate the growth of dendrites.

A 2015 article by M. A. Deyab (Journal of Power Sources 292 (2015) 66-71) mentions the effects of polyoxyethylene (40) nonylphenyl ether as a nonionic surfactant (PNE) as a corrosion inhibitor in the alkaline electrolyte (7.0 M KOH).

State-of-the-art research mentioning the addition of wetting agents is all related to the search for a reduction in the development of hydrogen coupled with the corrosion of zinc.

### BRIEF SUMMARY OF THE INVENTION

The invention aims to propose rechargeable alkaline electrochemical generators with a zinc anode making it possible to obtain an improvement in the stability of battery capacity and an increase in their cycle life.

This aim is achieved in particular by strengthening and stabilizing the membrane's hydrophilic properties, which allows a reduction in surface tensions and improves the contact of the electrolyte on solid surfaces.

More specifically, the invention relates to an alkaline electrochemical generator with a zinc anode according to the following statement 1:
1. An alkaline electrochemical generator with a zinc anode that contains an electrolyte which is an alkaline aqueous solution having a hydroxyl anion molar concentration of between 4M and 15M and comprising:
a) at least one wetting agent at a concentration of between 0.1 g/l and 50 g/l of electrolyte; and
b) at least one antifoam agent in an amount of between 10 mg and 1,000 mg per kilogram of electrolyte.

Advantageous characteristics of the alkaline electrochemical generator with a zinc anode in the aforementioned statement 1 are indicated in the following statements 2 to 11:
2. An alkaline electrochemical generator with a zinc anode according to statement 1, in which it comprises at least one ionic wetting agent and at least one nonionic agent.
3. An alkaline electrochemical generator with a zinc anode according to statement 1 or 2, comprising the ionic wetting agent called bis(2-ethylhexyl) phosphate.
4. An alkaline electrochemical generator with a zinc anode according to one of statements 1 to 3, comprising at least one nonionic wetting agent chosen from alkyl polyglucosides and polyethylene glycol and alkylphenol ethers, in particular octylphenol.
5. An alkaline electrochemical generator with a zinc anode according to one of statements 1 to 4, in which the antifoam agents are chosen from polyorganosiloxanes.
6. An alkaline electrochemical generator with a zinc anode according to one of statements 1 to 5, in which the molarity of the alkaline solution is between 7 and 12 M.
7. An alkaline electrochemical generator with a zinc anode according to one of statements 1 to 6, in which the concentration of the wetting agent(s) in the electrolyte is between 1 g/l and 25 g/l.
8. An alkaline electrochemical generator with a zinc anode according to one of statements 1 to 7, in which the concentration of the antifoam agents in the electrolyte is from 100 mg to 500 mg per kilogram of electrolyte.
9. An alkaline electrochemical generator with a zinc anode according to one of statements 1 to 8, in which the electrolyte further contains silicates.
10. An alkaline electrochemical generator with a zinc anode according to one of statements 1 to 9, in which the electrolyte further contains zincates.
11. An alkaline electrochemical generator with a zinc anode according to one of statements 1 to 10, in which the electrolyte further contains borates, phosphates, and/or fluorides.

According to another aspect, the invention further pertains to a method for preparing an aforementioned alkaline electrochemical generator with a zinc anode, according to the following statement 12:
12. A method for preparing an alkaline electrochemical generator with a zinc anode according to one of statements 1 to 11, comprising a step of introducing lithium, sodium, and/or potassium hydroxides during the preparation of the electrolyte.

Other characteristics and advantages of the invention will now be described in detail in the following description, which is given with reference to the appended figures, which schematically show:

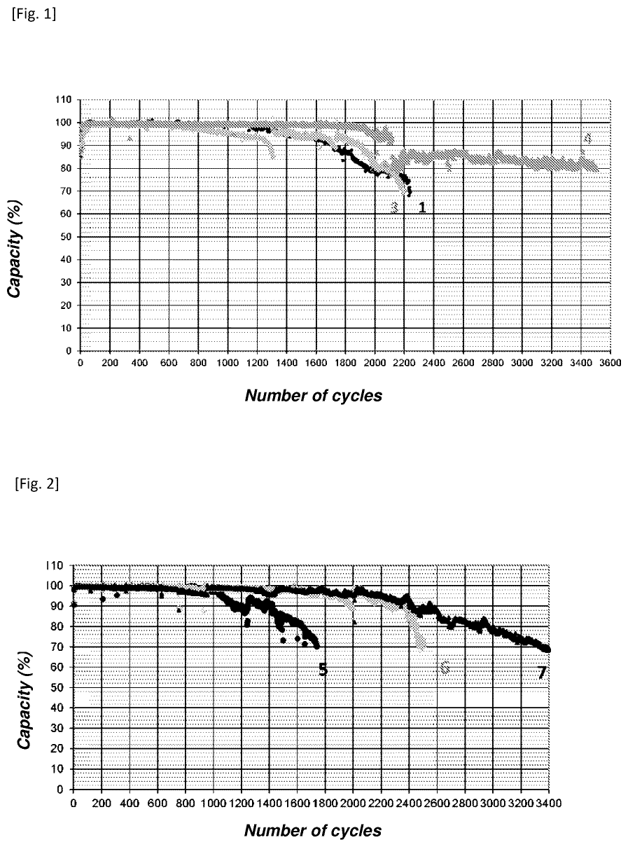

FIG. 1: curves of the capacities measured in discharge of NiZn elements, 8 Ah in cycling, 8 A charge in 1 hour, 8 A 1V discharge, 100% discharge depth;

FIG. 2: curves of the capacities measured in discharge of NiZn elements, 8 Ah in cycling, 8 A charge in 1 hour, 8 A 1V discharge, 100% discharge depth; and

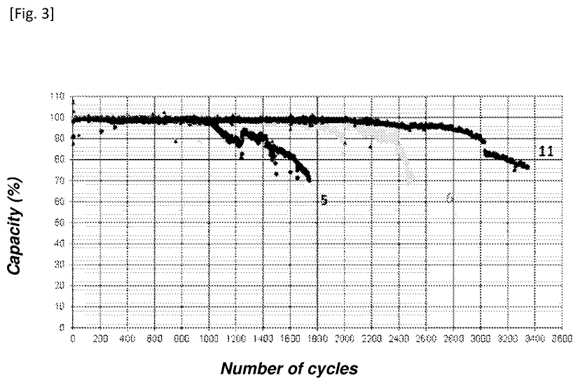

FIG. 3: curves of the capacities measured in discharge of NiZn elements, 8 Ah in cycling, 8 A charge in 1 hour, 8 A 1V discharge, 100% discharge depth.

### DETAILED DESCRIPTION OF THE INVENTION

The zinc-anode battery is produced according to methods known to those skilled in the art. The electrodes are in the form of plates, consisting of a current collector and an active mass. The active mass may incorporate compounds that are not involved in the electrochemical reaction but that will provide, for example, an electronic conduction function or a mechanical bond between the active elements and the collector, or even a retention function for the product of the electrochemical reaction.

In the case of the zinc anode, in addition to polymers such as PTFE, polyethylene glycol, polyvinyl alcohol, styrene-butadiene polymer, carboxymethyl cellulose, etc., which act as a binder for the constituents of the electrode, calcium hydroxide can be used to limit the formation of soluble zincates, as well as conductive ceramics as described in patent FR 2,788,887.

A separator isolates the anodic and cathodic compartments; it is a felt, a porous or ion-exchange membrane, felt and porous membrane that can be combined. The membrane is generally a hydrophobic polymer membrane that is modified to become hydrophilic by the addition of one or more wetting agents.

Depending on the method of manufacture, the zinc-anode battery may be prismatic, cylindrical, or in the form of a filter-press type cell if the battery is of the bipolar type.

The present invention is particularly applicable to the manufacture of a nickel-zinc battery, designed according to the main characteristics described below.

According to a preferred embodiment, a nickel-zinc battery is produced by combining a nickel electrode of the plasticized type and a zinc electrode also containing an organic binder.

### 1) Nickel Electrode

The nickel electrode can advantageously be made by using a nickel metal foam with very fine pores as a collector. Some of these foams are referred to as “battery grade” foam. Suppliers include, for example, Sumitomo Electric (Japan) and Corun (China). The thickness of the foam is chosen according to the desired surface capacity of the nickel electrode; it is generally between 1.2 and 2 mm, but it can be rolled to adjust the thickness precisely to the desired surface capacity.

The active material consists of nickel hydroxide that preferably further contains coprecipitated zinc and cobalt. The particles are preferably spherical or spheroidal in shape to increase volume capacity. They can be coated with cobalt oxide and hydroxide which, during the formation of the battery, are transformed into conductive cobalt oxyhydroxide (Oshitani et al. J. Electrochem. Soc. 1989 136, 6, 1590).

Conductive additives (fibers, metal powders) can also be added to the nickel hydroxide powder.

A paste is prepared by mixing the components described above and deionized water, to which carboxymethyl cellulose has been added. A polymeric binder, such as PTFE, can be added as a suspension, at this stage of manufacture or subsequently after filling the manifold, particularly nickel foam, with the active paste by dipping into the suspension.

The filling of the nickel foam can be carried out either on a laboratory scale using a blade that causes the paste to penetrate the thickness of the support or on an industrial scale by pressurized injection of the paste into the foam.

After drying, the electrode is compressed to ensure cohesion between collector, active mass, and additives and then cut to the desired dimensions.

### 2) Zinc Electrode

The zinc electrode collector may be in the form of a perforated metal strip, woven fabric, an expanded strip, or metal foam. Copper is preferred because of its conductivity, but it must be coated with a protective metal, such as zinc, tin, or an alloy.

The zinc electrode is manufactured by first preparing a paste consisting of zinc oxide and various additives:

Electronic conductors: metallic zinc, carbon, copper, conductive ceramics, etc., in the form of powders or filaments.

Anticorrosion agents: indium, bismuth, etc.

Compounds that react with zincates: calcium hydroxide, barium hydroxide, etc.

The liquid phase is deionized water or alcohol, to which carboxymethyl cellulose has been added as a binder and thickener. Other binders may be added, such as those mentioned in patent application EP 1,715,536.

Depending on the chosen method, it is possible to manufacture a high-viscosity paste that can be applied by pressure to both sides of the metal support to form a “sandwich” structure or to manufacture a medium-viscosity paste in which the collector is immersed and then left by removing the excess paste to adjust the thickness of the electrode using a blade, the operation being followed by drying. Finally, it is possible to use a dry powder mixed with a binder and to compress it on the metal support to constitute the electrode.

### 3) The Electrolyte

The electrolyte used is preferably a concentrated alkaline solution with a molarity of between 4 and 15 M (4 and 15 moles/l) and preferably between 4 and 12 M, of hydroxyl anions. The alkalinity is provided by potassium, sodium, and lithium hydroxides, taken individually or as a mixture.

The electrolyte may also contain zincates and silicates in varying proportions, as mentioned in patent FR 3,099,851. The electrolyte may also contain borates, phosphates, and fluorides, taken separately or as a mixture, as described, for example, in patent U.S. Pat. No. 5,215,836.

According to the present invention, the quantity of wetting agents added to the electrolyte is between 0.1 g/l and 50 g/l and preferably between 1 g/l and 25 g/l of electrolyte; the amount of antifoam agents added to the electrolyte, expressed in mg per kg of electrolyte, is between 10 mg and 1,000 mg.

The wetting agents are in particular selected from the ionic wetting agent, bis(2-ethylhexyl) phosphate, and nonionic wetting agents from alkyl polyglucosides, in particular those of the Triton® brand. The antifoam agents are selected from products that refer to the chemical family of polyorganosiloxanes. These wetting and antifoam agents can be used separately or as mixtures.

In order to illustrate the demonstration of the operation and the definition of the present invention, NiZn elements from 1 to 11, with a nominal capacity of 8 Ah, are produced in an identical manner according to the general description provided above. The elements 1 to 4 have a zinc electrode of a different composition from that of the elements 5 to 11. All the elements have identical nickel electrodes. The electrolyte used is a concentrated alkaline solution with a hydroxyl anion molar concentration of 10 M with an addition of silicate as described in patent FR 3,099,851. The electrolyte is modified for elements 3, 4 and 8 to 11 by the additions of wetting agents and antifoam agents. The elements are mounted with a low-pressure valve of 0.2 bar. The batteries have been cycled at a constant current of 8 A, equivalent to the rate of C with a charge of one hour corresponding to 100% charge and a complete discharge that ends when the voltage reaches 1V. The parameters that differentiate elements 1 to 11, as well as the number of cycles reached for a capacity greater than 70% of the nominal capacity (Cn) are summarized in Table 1 below.

TABLE 1
characteristics of NiZn batteries, nominal capacity 8 Ah, cycling charge 8 A 1 hr, discharge
at 100% 8 A 1 V; the symbol > indicates that the experiment is still in progress.

| | | | | | Antifoam | Loss of | |
|---|---|---|---|---|---|---|---|
| | | | | Wetting | agents | mass (%) | Number of |
| | | | Zinc | agents | (mg/kg of | at 2,000 | cycles |
| Element | Electrolyte | Membrane | electrode | (g/l) | electrolyte) | cycles | C >70% Cn |
| 1 | 10M silicates | A | 1 | no | no | 8% | 2,240 |
| 2 | 10M silicates | B | 1 | no | no | — | 0 |
| 3 | 10M silicates | B | 1 | 21.3 | no | 44% | 2,180 |
| 4 | 10M silicates | A | 1 | 21.3 | 100 | 21% | >3,500 |
| 5 | 10M silicates | A | 2 | no | no | 18% at | 1,740 |
| | | | | | | 1,600 | |
| | | | | | | cycles | |
| 6 | 10M silicates | A | 2 | 21.3 | 100 | 57% | 2,500 |
| 7 | 10M silicates | A | 2 | 21.3 | 100 | 45% | 3,400 |
| 8 | 10M silicates | A | 2 | 10.65 | 200 | 11.8% | 2,120 |
| 9 | 10M silicates | A | 2 | 7.1 | 200 | 9.3% | 2,220 |
| 10 | 10M silicates | A | 2 | 5.3 | 200 | 13% | 2,520 |
| 11 | 10M silicates | A | 2+ | 10.65 | 200 | 4% | >3,350 |

### Example 1 (Control)

NiZn elements from 1 to 4, with a nominal capacity of 8 Ah, are produced in an identical manner according to the general description provided above. The elements 1 to 4 have a zinc electrode of a different composition from that of the elements 5 to 11. All the elements have identical nickel electrodes. The electrolyte used is a concentrated alkaline solution with a hydroxyl anion molar concentration of 10M with an addition of silicate as described in patent FR 3,099,851.

Two membranes A and B were used for these elements. Membrane A is a microporous polypropylene that is 25 μm thick with an added wetting agent. The breathability of this membrane A, expressed in Guerley, is relatively high, greater than 1,000, allowing it to be a gas barrier for thermal stability by limiting the recombination of oxygen at the surface of the zinc electrode. This membrane covers the zinc electrode with two layers of membrane, one on top of the other, creating a barrier with a thickness of 50 μm. Membrane B a microporous polypropylene that is 40 μm thick with an added wetting agent. The breathability of this membrane B, expressed in Guerley, is lower than that of membrane A, between 450-750. This wide range suggests homogeneity defects in the added wetting agent layer. This membrane B covers the surface of the zinc electrode with a single layer.

Element 1, mounted with membrane A, demonstrates a cycle count of 2,240 cycles before its capacity becomes less than 70% of 8 Ah. Element 2, mounted with membrane B, leads to a zero capacity after the formation step characterized by three cycles of charging at the rate of C/10 for 12 hours and discharging at the rate of C/5 until the voltage of the battery reaches 1.2V.

Element 3 is the previous element 2 after an addition in the electrolyte of four wetting agents, among which three are of the Triton® brand, BG-10, CG-110, and X-100, plus the bis(2-ethylhexyl) phosphate wetting agent. The total concentration of the four wetting agents added element 2, which thus becomes element 3, is 21.3 g/l. No antifoam agent is added. The capacities discharged as a function of the number of cycles for batteries 1 and 3 are compared in FIG. 1.

Following the addition of the wetting agents, element 2, which had demonstrated zero capacity and became element 3, performs 2,180 cycles, comparable to the result of element 1. The wetting agents added to the electrolyte were therefore able to be deposited in situ in the cell on the membrane, allowing this previously incompatible membrane to be functional and offer a life similar to that obtained with membrane A, with membrane A not having any obvious defect in the attachment of its wetting agent. This first experiment is therefore conclusive on the ability of the wetting agents added to the electrolyte to attach to the membrane and restore its hydrophilic properties.

However, two problems incompatible with sustainable operation have been noted, the first being the formation of foam in large quantities, capable of coming out of the batteries so as to involve leaks and the second consisting of significantly greater losses of mass. Thus, after 2,000 cycles, elements 1 and 3 lost 8% and 44%, respectively, of their electrolyte mass. Beyond about 20% electrolyte mass loss, additions of water are desirable to avoid a drop in capacity by drying the batteries.

### Example 2 (Invention)

Element 4, with a nominal capacity of 8 Ah, is produced in an identical manner according to the general description provided above. Element 4 is identical to element 1 concerning the zinc and nickel electrodes and membrane A. The electrolyte used is a concentrated alkaline solution with a hydroxyl anion molar concentration of 10M with an addition of silicate as described in patent FR 3,099,851, to which four wetting agents are added, among which three are of the Triton® brand, BG-10, CG-110, and X-100, plus the bis(2-ethylhexyl) phosphate wetting agent. The total concentration of the four wetting agents is 21.3 g/l. An antifoam agent of the chemical family of polyorganosiloxanes is added to the electrolyte, at a rate of 100 mg per kilogram of electrolyte. The battery has been cycled at a constant current of 8 A, equivalent to the rate of C with a charge of one hour and a discharge that ends when the voltage reaches 1V.

The capacities discharged as a function of the number of cycles for batteries 1, 3, and 4 are compared in FIG. 1. Even if the membrane A has no obvious defect in the attachment of its wetting agent, the obtained result of more than 3,500 cycles shows that the wetting agents introduced into the electrolyte significantly improve the cycling life of this battery, the wetting agents introduced into the electrolyte having the ability to attach to the membrane A and maintain or restore the hydrophilic properties of the latter. The addition of the antifoam agent made it possible to greatly reduce the formation of foam. The loss of mass after 2,000 cycles is 21% or about three times that of element 1, at 8% without wetting agents. A simple addition of water makes it possible to compensate for the greater losses of mass and to demonstrate a higher number of cycles using the addition of wetting and antifoam agents to the electrolyte.

### Example 3 (Control and Invention)

Element 5 (control), with a nominal capacity of 8 Ah, is produced in an identical manner according to the general description provided above. It is identical to element 1 concerning the nickel electrodes and membrane A, but its zinc electrodes are of a different composition. The electrolyte used is a concentrated alkaline solution with a hydroxyl anion molar concentration of 10M with an addition of silicate as described in patent FR 3,099,851.

Element 6 (invention) is the previous element 5, but with an addition to the electrolyte of four wetting agents, among which three are of the Triton® brand, BG-10, CG-110, and X-100, plus the bis(2-ethylhexyl) phosphate wetting agent. The total concentration of the four wetting agents is 21.3 g/l. An antifoam agent of the chemical family of polyorganosiloxanes is added to the electrolyte at a rate of 100 mg per kilogram of electrolyte.

Element 7 (invention) is the previous element 5, but with an addition to the electrolyte of two wetting agents of the Triton® brand, BG-10 and X-100. The total concentration of the two wetting agents is 21.3 g/l. An antifoam agent of the chemical family of polyorganosiloxanes is added to the electrolyte at a rate of 100 mg per kilogram of electrolyte.

These three batteries have been cycled at a constant current of 8 A, equivalent to the rate of C with a charge of one hour and a discharge that ends when the voltage reaches 1V. The capacities discharged as a function of the number of cycles for batteries 5, 6, and 7 are compared in FIG. 2.

The addition of the wetting agents improves the number of cycles relative to element 5 by 44% for element 6 at 2,500 cycles and by 95% for element 7 at 3,400 cycles. The addition of the antifoam agent made it possible to greatly reduce the formation of foam. The loss of mass after 2,000 cycles for elements 5, 6 and 7 is 18%, 57%, and 45%, respectively, a factor of about 2 to 3 between elements with and without wetting agents. A simple addition of water makes it possible to compensate for the greater losses of mass and to demonstrate a higher number of cycles using the addition of wetting and antifoam agents to the electrolyte.

### Example 4 (Invention)

To limit the formation of foam linked to the addition of wetting agents, the amount of antifoam agent is doubled, from 100 mg to 200 mg per kilogram of electrolyte.

To limit the losses of mass, the quantity of wetting agents is also reduced.

A new set of three elements makes it possible to evaluate the result of adding wetting agents in smaller quantities, namely 10.65 g/l, 7.1 g/l, and 5.3 g/l for elements 8, 9, and 10, respectively.

Elements 8, 9, and 10 are identical to element 5, except for the additions of wetting and antifoam agents. These batteries have been cycled at a constant current of 8 A, equivalent to the rate of C with a charge of one hour and a discharge that ends when the voltage reaches 1V.

The numbers of cycles obtained, reported in Table 1, of 1,740, 2,120, 2,220, 2,520, and 2,500, for elements 5, 8, 9, 10, and 6, respectively, demonstrate that it is possible to preserve the action of wetting agents with lower concentrations. With these lower concentrations and the doubling of the antifoam mass, foam formation and mass losses are significantly reduced with, after 2,000 cycles, 11.8%, 9.3%, and 13% for elements 8, 9 and 10, respectively.

### Example 5 (Invention)

Our analyses suggest that the detachment of the wetting agents from the membrane is likely to be accelerated by strong oxygen recombinations on the surface of the zinc electrode. Sometimes, the heat production associated with this reaction results in decreases at the end of charging the battery voltage, commonly referred to as “negative delta V” in the state of the art.

To limit this phenomenon, the structure of the zinc electrodes has been slightly modified for element 11.

Apart from this modification, element 11 is the previous element 8 and similar to elements 5 and 6, with an addition to the electrolyte of four wetting agents, among which three are of the Triton® brand, BG-10, CG-110, and X-100, plus the bis(2-ethylhexyl) phosphate wetting agent. The total concentration of the four wetting agents in element 11 is 10.65 g/l, reduced by half relative to that of element 6. An antifoam agent of the chemical family of polyorganosiloxanes is added to the electrolyte at a rate of 200 mg per kilogram of electrolyte, or double that of element 6.

Battery 11 has been cycled at a constant current of 8 A, equivalent to the rate of C with a charge of one hour and a discharge that ends when the voltage reaches 1V.

The capacities discharged as a function of the number of cycles for batteries 5, 6, and 11 are compared in FIG. 3.

Following this combination, the stability of the capacity of element 11 increases further with more than 3,350 cycles, the test being still in progress. The loss of mass after 2,000 cycles for elements 5, 6 and 11 is 18%, 57%, and 4%, respectively, demonstrating that the formation of foam and the loss of mass associated with the addition of wetting agents are improved and compatible with an addition of water pushed to a greater number of cycles.

Compared to the results measured on element 8, the improvement in the behavior of element 11—mass loss at 2,000 cycles reduced by 65% and number of cycles increased by at least 55%—demonstrates an enhanced stabilization associated, for the authors of the present invention, with a reduction in the consequences induced by the recombination of oxygen, and therefore with better preservation of the wetting agents, both in the electrolyte and in the membrane.

Through the many experiments conducted by the authors of the present invention, of which those presented in Table 1 constitute only a part, it appears that the concentrations of wetting agents and antifoam agents can favorably be chosen in broad ranges. The optimal concentrations are particularly dependent on the characteristics of the membranes used, the level of alkalinity of the electrolyte, the formulations and embodiments of the electrodes, the battery configurations, and the conditions of the cycling. It has thus been shown that the overall concentrations of wetting agents can advantageously be between about 0.1 and 50 g per liter of electrolyte, and those of antifoam agents between about 10 and 1,000 mg per kilogram of electrolyte.

At the zinc electrode, metal zinc is formed during charging by reducing the zincate ions present in the solution. The zinc deposit will incorporate, into its mass, particles present at the site of its germination.

During the discharge of the zinc electrode, the zinc is transformed into zincate ions, partially stripping its surface before it is again covered by the deposit of zinc oxide characterizing the anodic active material in the discharged state. During the stripping step, depositions or trappings in the zinc may also be released into the electrolyte and redeposited on site or elsewhere, such as on the membrane in particular.

This release into the electrolyte is favored when there is low affinity between the zinc and the wetting agent, which is the case with nonionic wetting agents. Because the membrane is in the immediate vicinity of the surface of the zinc electrode, this mechanism is likely to supply the membrane with wetting agents and stabilize its hydrophilic properties over time.

This phenomenon is similar to a membrane's self-repair mechanism.

1. An alkaline electrochemical generator with a zinc anode that contains an electrolyte which is an alkaline aqueous solution having a hydroxyl anion molar concentration of between 4M and 15M and comprising:
a) at least one wetting agent at a concentration of between 0.1 g/l and 50 g/l of electrolyte; and
b) at least one antifoam agent in an amount of between 10 mg and 1,000 mg per kilogram of electrolyte;
characterized in that:
the electrolyte comprises the ionic wetting agent which is bis(2-ethylhexyl) phosphate; and/or
the electrolyte comprises at least one nonionic wetting agent selected from alkyl polyglucosides and polyethylene glycol and alkylphenol ethers; and/or
the antifoam agents are chosen from polyorganosiloxanes.

2. An alkaline electrochemical generator with a zinc anode according to claim 1, comprising at least one ionic wetting agent and at least one nonionic agent.

3. An alkaline electrochemical generator and zinc anode according to claim 1, wherein the molarity of the alkaline solution is between 7 and 12 M.

4. An alkaline electrochemical generator with a zinc anode according to claim 1, wherein the concentration of the wetting agent(s) in the electrolyte is between 1 g/l and 25 g/l.

5. An alkaline electrochemical generator with a zinc anode according to claim 1, wherein the concentration of the antifoam agents in the electrolyte is from 100 mg to 500 mg per kilogram of electrolyte.

6. An alkaline electrochemical generator with a zinc anode according to claim 1, wherein the electrolyte further contains silicates.

7. An alkaline electrochemical generator with a zinc anode according to claim 1, wherein the electrolyte further contains zincates.

8. An alkaline electrochemical generator with a zinc anode according to claim 1, wherein the electrolyte further contains borates, phosphates, and/or fluorides.

9. (canceled)

10. An alkaline electrochemical generator with a zinc anode according to claim 1, comprising at least one ionic wetting agent and at least one nonionic agent and wherein the molarity of the alkaline solution is between 7 and 12 M.

11. An alkaline electrochemical generator with a zinc anode according to claim 1, comprising at least one ionic wetting agent and at least one nonionic agent and wherein the concentration of the wetting agent(s) in the electrolyte is between 1 g/l and 25 g/l.

12. An alkaline electrochemical generator with a zinc anode according to claim 1, comprising at least one ionic wetting agent and at least one nonionic agent and wherein the concentration of the antifoam agents in the electrolyte is from 100 mg to 500 mg per kilogram of electrolyte.

13. An alkaline electrochemical generator with a zinc anode according to claim 1, comprising at least one ionic wetting agent and at least one nonionic agent and wherein
the molarity of the alkaline solution is between 7 and 12 M and
the concentration of the wetting agent(s) in the electrolyte is between 1 g/l and 25 g/l.

14. An alkaline electrochemical generator with a zinc anode according to claim 1, comprising at least one ionic wetting agent and at least one nonionic agent and wherein
the molarity of the alkaline solution is between 7 and 12 M and
the concentration of the antifoam agents in the electrolyte is from 100 mg to 500 mg per kilogram of electrolyte.

15. An alkaline electrochemical generator with a zinc anode according to claim 1, comprising at least one ionic wetting agent and at least one nonionic agent and wherein
the molarity of the alkaline solution is between 7 and 12 M,
the concentration of the wetting agent(s) in the electrolyte is between 1 g/l and 25 g/l and
the concentration of the antifoam agents in the electrolyte is from 100 mg to 500 mg per kilogram of electrolyte.

16. A method for preparing an alkaline electrochemical generator with a zinc anode according to claim 1, comprising a step of introducing lithium, sodium, and/or potassium hydroxides during the preparation of the electrolyte.
